(19) United States
(12) Patent Application Publication
(10) Pub. No.: US 2007/0146329 A1
(43) Pub. Date: Jun. 28, 2007

(54) Touch keyboard

(76) Inventors: Wei-Hsien Huang, Taipei (TW); Jen-Chin Chiu, Taipei (TW); Jui-Kuang Wei, Taipei (TW)

Correspondence Address: HARNESS, DICKEY & PIERCE, P.L.C., P.O. BOX 8910, RESTON, VA, 20195, US

(21) Appl. No.: 11/600,231

(22) Filed: Nov. 16, 2006

(30) Foreign Application Priority Data
Dec. 22, 2005 (TW) 094222418

(51) Int. Cl. G09G 5/00

(52) U.S. Cl. 345/168

(57) ABSTRACT

A touch keyboard is provided, which mainly includes a touch panel to be sensed and actuated by touching with fingers and other objects, so as to execute instructions. A light-emitting display interface is mounted and integrated with the touch panel corresponding to a position sensed on the touch panel, and the corresponding position sensed on the touch panel is displayed through a light-emitting diode of the light-emitting display interface, such that the touch keyboard has the same function of inputting characters as that of an ordinary keyboard, and the output data sensed is then transmitted to the microprocessors, cell phones, or other products requiring an electronic key-in interface through a transmission device connected to both the touch panel and the light-emitting display interface, wherein the transmission device acts as a transmission interface between the touch keyboard and microprocessors, cell phones, or products requiring a key-in interface.

### CROSS-REFERENCE TO RELATED APPLICATIONS

This non-provisional application claims priority under 35 U.S.C. § 119(a) on Patent Application No(s). 094222418 filed in Taiwan, R.O.C. on Dec. 22, 2005, the entire contents of which are hereby incorporated by reference.

### BACKGROUND OF THE INVENTION

1. Field of Invention

The present invention relates to a touch keyboard, and more particularly, to a keyboard utilizing a touch panel integrated with a display body of a light-emitting diode, such that it is convenient for a user to change an input display on the keyboard and easily clean the surface of the keyboard.

2. Related Art

A keyboard is a device used for inputting all kinds of messages into electronic devices, and the so-called messages may be divided into two types: text message and control message.

Text messages are those used for achieving an object of inputting texts to electronic devices by utilizing keys with various English letters and symbols printed thereon on the keyboard. While control messages are those used for achieving an object of controlling electronic devices to meet the requirements of a user by utilizing keys on the keyboard, such as F1, Esc, Delete, etc.

In such an era of science and technology when information is being rapidly developed, users may select products associated with styles and diversified functions for satisfying a personal favor.

Currently, computers, cell phones, and all products requiring an electronic key-in interface are all widely used, and will continue to experience vigorous development into the future. The keyboard is now one of the communication media between electronic devices and a user, and although the keyboard of electronic devices takes more time in inputting data and meanwhile is inconvenient for practical usage, the conventional touch-tone keyboard of electronic devices is hardly to be replaced by other types of input devices before techniques of speech recognition and optical recognition of characters have prevailed, therefore, keyboard products will still be equipped in systems such as personal computers, work stations, and cell phones, and all products requiring a key-in interface, etc.

Also, when using a conventional keyboard, noises are easily produced, which may disturb adjacent workers, such that they easily lose concentration and become fidgety, thereby work efficiency is reduced. If used in a quiet circumstance, a conventional keyboard will disturb a user or adjacent workers.

Also, a conventional keyboard is made by integrating different individual units of keys into a whole. A user worries that some gaps appear between keys of different units, and thereby dirt easily exists therein and accordingly a large number of viruses will be generated in the gaps, such that the user is susceptible to illness. The generation of viruses is accelerated due to users' different use habits considering, e.g., computer keyboards used in Internet cafes or public telephones. However, no better way has appeared, besides periodically cleaning the keyboard, while is difficult for a conventional keyboard due to its smaller gaps, thereby increasing the disturbance of the user.

### SUMMARY OF THE INVENTION

In view of the above-mentioned problems, an object of the present invention is to provide a touch keyboard, thereby solving some problems in the related art.

Therefore, in order to achieve the above-mentioned objects, a touch keyboard is disclosed in the present invention, which includes a touch panel to be sensed and actuated by touching with fingers and other objects, so as to execute instructions. A light-emitting display interface is mounted above and integrated with the touch panel corresponding to a position sensed on the touch panel, and the corresponding position sensed on the touch panel is displayed through a light-emitting diode of the light-emitting display interface, such that the touch keyboard has the same function of inputting characters as that of an ordinary keyboard. The output data sensed is then transmitted to microprocessors, cell phones, or any product requiring an electronic key-in interface, through a transmission device connected to both the touch panel and the light-emitting display interface.

The design of integrating a touch panel with a light-emitting display interface is utilized in the present invention, therefore, the light-emitting display interface is integrated with the touch panel corresponding to a position sensed on the touch panel, and the corresponding position sensed on the touch panel will be displayed through a light-emitting diode of the light-emitting display interface, such that the touch keyboard has the same function of inputting characters as that of an ordinary keyboard, and the displaying through the light-emitting display interface can be changed in real time according to the habits of the user, so as to facilitate usage. And applying the touch panel to the keyboard can greatly reduce the noises produced when using the keyboard, which is a remarkable advantage.

Furthermore, the design of integrating a touch panel with a light-emitting display interface is used in the present invention, such that there is no gap between the keys on the touch keyboard. Therefore, the touch keyboard can be easily cleaned, and the disadvantage that dirt tends to exist within the gaps of the conventional keyboard can be improved.

Features and examples of the present invention will be illustrated below in detail through preferred embodiments, with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is an exploded diagram of a touch keyboard according to the present invention;

FIG. 2 is stereogram of the touch keyboard according to the present invention;

FIG. 3 is a diagram of an embodiment of a protruding particle on the touch panel of the touch keyboard according to the present invention; and

FIG. 4 is a diagram of an embodiment of the touch keyboard according to the present invention.

### DETAILED DESCRIPTION OF THE INVENTION

Specific embodiments are given below to illustrate the content of the present invention in detail with reference to the accompanying drawings. Reference numerals mentioned in the illustration are those in drawings.

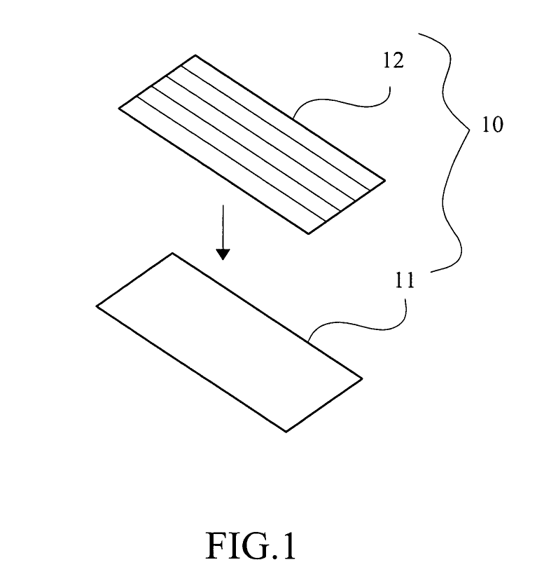

Please refer to FIG. 1 of an exploded diagram of a touch keyboard 10 according to the present invention. As shown in FIG. 1, the touch keyboard 10 includes a touch panel 11 with a light-emitting display interface 12 mounted thereon. The light-emitting display interface 12, which may be a display interface of a light-emitting diode (LED) or an organic light-emitting diode (OLED), is integrated with the touch panel 11. Meanwhile, positions of light-emitting characters of the light-emitting display interface 12 are corresponding to positions sensed on the touch panel 11, such that the touch keyboard 10 has the same function of inputting characters as that of an ordinary keyboard.

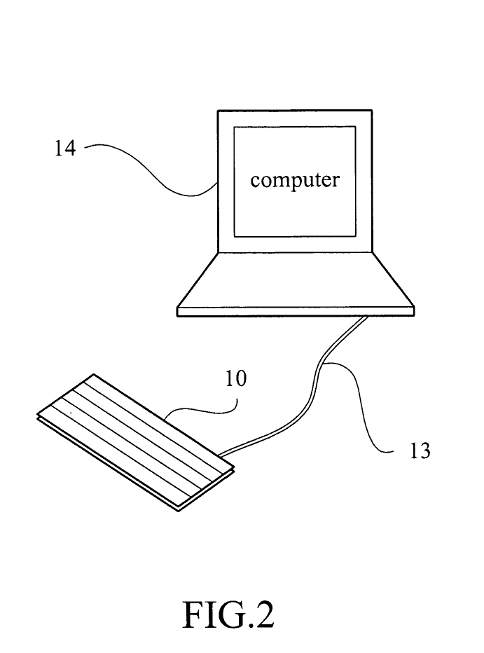

Please refer to FIG. 2 of a stereogram of the touch keyboard according to the present invention. As shown in FIG. 2, the output data sensed by the touch panel 11 are then transmitted into a microprocessor 14 of the computer via a transmission device 13 connected between the touch panel 11 and the light-emitting display interface 12 of the touch keyboard 10. The transmission device 13 functions as a transmission interface between the touch keyboard 10 and the microprocessor 14. As described above, the touch panel 11 of the touch keyboard 10 can be sensed and actuated by touching with fingers and other objects so as to execute an instruction.

Therefore, according to the physical principle for the touch panel 11 to detect a contact, the touch keyboard 10 can be divided into three types: a resistance-type screen, wherein a voltage is generated by a gentle press with fingers or other contact heads; a capacitance-type screen, typically used for touchpads of notebook computers, wherein a tiny current will pass through fingers. As for the third type of a fluctuation-type screen, the entire surface is covered by acoustic waves or infrared rays, and a finger or a contact head can block these standing wave patterns.

The resistance-type screen is the one with the longest history, is the most widely used, and has the lowest price, and any kinds of contact head, a finger, or a pen point can be used. The capacitance-type screen requires using fingers, or a contact head connected to a ground line so as to enable the current to pass through. The fluctuation-type screen is the newest and most expensive type. An acoustic-wave-on-surface screen is required to be gently touched by fingers or by a soft contact head, for example, the eraser of a pencil, such that the surface energy can be absorbed; whereas as for an infrared-ray-touch screen, any kind of contact head can be used.

Usages are respectively described as follows:

### Resistance-Type Touch Screen

When using a resistance-type touch panel 11, the top layer is a layer of polyester sheet with a conductive metal film coated on the inner side. The bottom layer, that is, the layer adhered on a cathode-ray tube (CRT) or on a liquid crystal display (LCD), is a piece of glass plate coated with a conductive material. The glass plate is separated from the polyester sheet by a layer of tiny “division points” made of polyester. Along X axis of the glass plate and Y axis of the polyester sheet is respectively provided with one controller for applying a tiny voltage gradient. Once a position of a character of the light-emitting display interface 12 is touched by fingers, the touch panel 11 presses two pieces of conductive layers together due to receiving a pressure from being touched, such that an electronic device can detect X coordinate and Y coordinate of the contact, and then output data sensed are then transmitted to, e.g., the microprocessor 14 in the computer via the transmission device 13.

### Capacitance-Type Touch Screen

As for the glass plate of a capacitance-type touch panel 11, conductive materials are coated on both sides, and a scratching-resistant film is coated on the external side. Electrodes around the glass plate produce an even electric field with a low voltage on an external conductive layer; whereas an internal conductive layer provides an electromagnetic shield and reduces noises. Once a position of a character of the light-emitting display interface 12 is touched by fingers, the touch panel 11 forms a capacitive couple with the electric field on the external conductive layer due to receiving a pressure from being touched, thereby absorbing a tiny current. Each electrode is used to measure the current from each corner, and then a coordinate of the finger is determined by a controller, and the output data sensed is then transmitted into, e.g., the microprocessor 14 in the computer via the transmission device 13.

### Fluctuation-Type Touch Screen

There is no film coated on the glass plate of a fluctuation-type touch panel 11. Converters located at four corners of the screen convert a signal from a controller into an ultrasonic wave on the glass plate, and reflectors located on four sides are used to produce a standing wave pattern. Once a finger contacts a position of a character of the light-emitting display interface, the touch panel 11 absorbs a part of standing waves due to receiving a pressure from being touched. At this time, the converters detect a relative attenuation, and the controller determines a coordinate of the finger, and the output data sensed are then transmitted into, e.g., the microprocessor 14 in the computer via the transmission device 13. Presently, there is also a sonic type, simply introduced as follows:

The principle of a sonic type touch panel is to utilize an advanced sonic sense, wherein a relative position of the finger is measured, and thereby a coordinate value is produced. The main structure is that, two sets of sonic transmitters and receivers are respectively disposed at four corners of a tempered glass, wherein one set is used to sense of the coordinate of X axis, while the other set is used to sense the coordinate of Y axis, which are then reflected to the entire touch panel by a reflector.

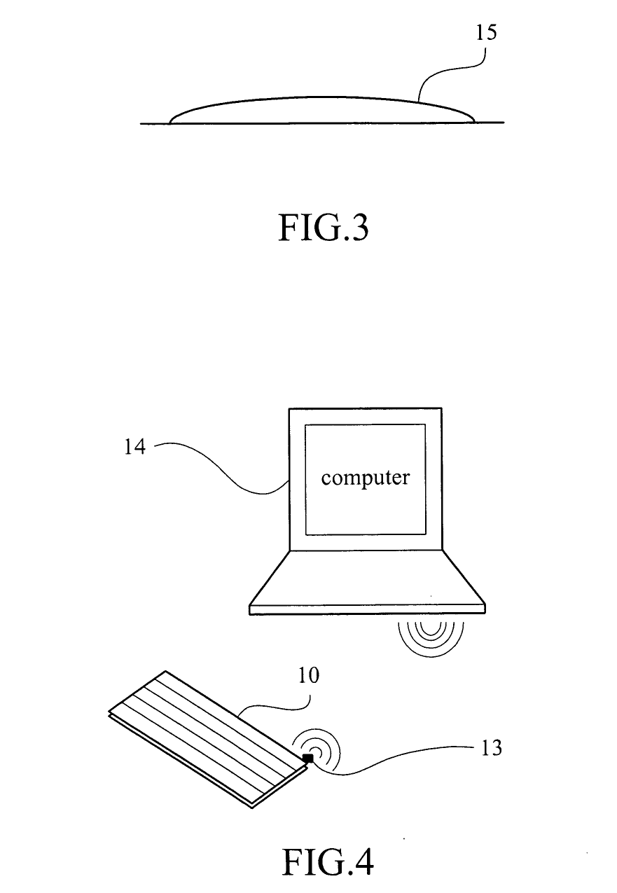

As for a keying feedback, when an action ordered by the brain has been finished by the finger, messages keyed in are sent back to the brain, which is referred as a feedback action. A keying feedback includes many forms, such as, touch, hearing, and vision, wherein a touch-type feedback is a relatively better one. As shown in FIG. 3, a protruding particle 15 is disposed on the touch panel or the light-emitting display interface of the touch keyboard of the invention to tell an operator that the key has been pressed down. In addition, a hearing-type feedback is also used, wherein a speaker element can be added, such that a clatter sound or another sound is produced by the speaker when the key is pressed down, and thereby an operator is aware of a keying state. A vision-type feedback is used to indicate the state of some specific keys during a long period, for example, displaying the state of Num Lock.

Please refer to FIG. 4 of a diagram of an embodiment of the touch keyboard according to the present invention. As shown in FIG. 4, a touch panel 11 is provided with a light-emitting display interface 12 mounted thereon. The light-emitting display interface 12 is integrated with the touch panel 11, and meanwhile a position of a light-emitting character of the light-emitting display interface 12 is corresponding to a relative position sensed on the touch panel 11, such that the touch keyboard 10 has the same function of inputting characters as that of an ordinary keyboard. And then the output data sensed by the touch panel 11 and the light-emitting display interface 12 are then wirelessly transmitted to, for example, a microprocessor 14 in the computer via a transmission device 13, which is a wireless transmission device, wirelessly connected between the touch panel 11 and the light-emitting display interface 12 of the touch keyboard 10, wherein the transmission device 13 is used as a transmitting interface between the touch keyboard 10 and the microprocessor 14.

In comparison with the prior art, the touch keyboard of the present invention can be widely applied to personal computers, work stations, cell phones, and all products requiring a key-in interface. Furthermore, the touch keyboard of the present invention is not only full of novel ideas, but display interfaces of input symbols required by the user in various countries can be freely changed through displaying of a light-emitting diode, wherein noises produced when hitting keys are reduced, such that adjacent workers will not be disturbed; and the touch keyboard can also be easily cleaned, thereby avoiding the problem that dirt exists, as in the gaps of a conventional keyboard.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A touch keyboard, comprising:
a touch panel;
a light-emitting display interface mounted on the touch panel for displaying characters at the position corresponding to the touch panel; and
a transmission device connected between the touch panel and the light-emitting display interface functioning as a transmission interface for microprocessors, cell phones, or products requiring an electronic key-in interface.

2. The touch keyboard as claimed in claim 1, wherein the touch panel comprises a resistance-type structure.

3. The touch keyboard as claimed in claim 1, wherein the touch panel comprises a capacitance-type structure.

4. The touch keyboard as claimed in claim 1, wherein the touch panel comprises a fluctuation-type structure.

5. The touch keyboard as claimed in claim 1, wherein the light-emitting display interface comprises a display interface of a light-emitting diode.

6. The touch keyboard as claimed in claim 1, wherein the light-emitting display interface comprises a display interface of an organic light-emitting diode.

7. The touch keyboard as claimed in claim 1, wherein protruding particles are further disposed on the touch panel.

8. The touch keyboard as claimed in claim 1, wherein protruding particles are further disposed on the light-emitting display interface.

9. The touch keyboard as claimed in claim 1, wherein the transmission device comprises an ordinary transmission line connected to a computer for transmitting data.

10. The touch keyboard as claimed in claim 1, wherein the transmission device comprises a wireless transmitting interface for wirelessly transmitting data between the transmission device and a computer.
